(19) United States
(12) Patent Application Publication
(10) Pub. No.: US 2008/0230385 A1
(43) Pub. Date: Sep. 25, 2008

(54) NOx SENSING SYSTEM HAVING NOx SENSOR AND METHOD FOR DETERMINING A NOx CONCENTRATION UTILIZING THE NOx SENSOR

(76) Inventors: Earl W. Lankheet, Grand Blanc, MI (US); David B. Quinn, Grand Blanc, MI (US)

Correspondence Address: CANTOR COLBURN, LLP, 20 Church Street, 22nd Floor, Hartford, CT, 06103, US

(21) Appl. No.: 11/689,909

(22) Filed: Mar. 22, 2007

(51) Int. Cl. G01N 27/416

(52) U.S. Cl. 204/431; 205/781

(57) ABSTRACT

A NOx sensing system having a NOx sensor and a method for determining a NOx concentration utilizing the NOx sensor are provided. The NOx sensor utilizes a second chamber communicating with ambient atmosphere with ambient oxygen for allowing an electrochemical cell to accurately measure an oxygen concentration in a first chamber communicating with an exhaust stream to more accurately control the oxygen concentration in the first chamber, without disassociating NOx therein. The more accurate control of the oxygen concentration in the first chamber, subsequently allows for a more accurate measurement of the NOx in the exhaust system.

### TECHNICAL FIELD

The present application is directed to a NOx sensing system having a NOx sensor and a method for determining a NOx concentration utilizing the NOx sensor.

### BACKGROUND

NOx sensors have been developed that measure a NOx concentration in an exhaust stream. However, the NOx sensors have not utilized a first chamber that communicates with ambient atmosphere as a reference for an electrochemical pump receiving exhaust gases from an exhaust stream in a second chamber. As such, the inventors herein have recognized the NOx sensors have been unable to control an amount of oxygen in the first chamber to a desired low concentration value, which adversely effects a NOx measurement in another chamber communicating with the second chamber.

Accordingly, the inventors herein have recognized a need for an improved NOx sensor that minimizes the above-mentioned deficiencies.

### SUMMARY OF THE INVENTION

A NOx sensor in accordance with an exemplary embodiment is provided. The NOx sensor includes a housing having a first chamber configured to receive NOx and oxygen from an exhaust stream, a second chamber configured to communicate with ambient atmosphere, a third chamber communicating with the first chamber, and a fourth chamber communicating with the third chamber. The NOx sensor further includes a first electrochemical pumping cell disposed between the first chamber and the second chamber. The first electrochemical pumping cell configured to pump oxygen from the first chamber into the second chamber such that an oxygen partial pressure in the first chamber is maintained greater than a first predetermined oxygen partial pressure level. The NOx and remaining oxygen in the first chamber migrates from the first chamber to the third chamber. The NOx sensor further includes a second electrochemical pumping cell disposed between the third chamber and the second chamber. The second electrochemical pumping cell is configured to pump oxygen from the third chamber to the second chamber such at an oxygen partial pressure in the third chamber is maintained less than a second predetermined oxygen partial pressure level. The NOx in the third chamber migrates to the fourth chamber. The NOx sensor further includes a third electrochemical pumping cell communicating with the fourth chamber, the third electrochemical pumping cell configured to decompose the NOx in the fourth chamber, wherein an output current of the third electrochemical pumping cell indicates a concentration of NOx in the fourth chamber.

A method for determining a concentration of NOx utilizing a NOx sensor in accordance with another exemplary embodiment is provided. The NOx sensor has a housing with a first chamber configured to receive NOx and oxygen from an exhaust stream, a second chamber configured to communicate with ambient atmosphere, a third chamber communicating with the first chamber, and a fourth chamber communicating with the third chamber. The NOx sensor further includes a first electrochemical pumping cell disposed between the first chamber and the second chamber. The NOx sensor further includes a second electrochemical pumping cell disposed between the third chamber and the second chamber. The NOx sensor further includes a third electrochemical pumping cell communicating with the fourth chamber. The method includes pumping oxygen from the first chamber into the second chamber utilizing the first electrochemical pumping cell such that an oxygen partial pressure in the first chamber is maintained greater than a first predetermined oxygen partial pressure level. The NOx and remaining oxygen in the first chamber migrate from the first chamber to the third chamber. The method further includes pumping oxygen form the third chamber to the second chamber utilizing the second electrochemical pumping cell such that an oxygen partial pressure in the third chamber is maintained less than a second predetermined oxygen partial pressure level, the NOx in the third chamber migrating to the fourth chamber. The method further includes decomposing the NOx in the fourth chamber utilizing the third electrochemical pumping cell, wherein an output current of the third electrochemical pumping cell indicates the concentration of NOx in the fourth chamber.

A NOx sensing system in accordance with another exemplary embodiment is provided. The NOx sensing system includes a NOx sensor having a housing with a first chamber configured to receive NOx and oxygen from an exhaust stream, a second chamber configured to communicate with ambient atmosphere, a third chamber communicating with the first chamber, and a fourth chamber communicating with the third chamber. The NOx sensor further includes a first electrochemical pumping cell disposed between the first chamber and the second chamber. The first electrochemical pumping cell is configured to pump oxygen from the first chamber into the second chamber such that an oxygen partial pressure in the first chamber is maintained greater than a first predetermined oxygen partial pressure level. The NOx and remaining oxygen in the first chamber migrate from the first chamber to the third chamber. The NOx sensor further includes a second electrochemical pumping cell disposed between the third chamber and the second chamber. The second electrochemical pumping cell is configured to pump oxygen from the third chamber to the second chamber such that an oxygen partial pressure in the third chamber is maintained less than a second predetermine oxygen partial pressure level. The NOx in the third chamber migrates to the fourth chamber. The NOx sensor further includes a third electrochemical pumping cell communicating with the fourth chamber. The third electrochemical pumping cell is configured to decompose the NOx in the fourth chamber. The NOx sensing system further includes a first voltage source configured to supply a variable voltage to the first electrochemical pumping cell, in response to a control signal. The NOx sensing system further includes a first current sensor configured to output a first signal indicative of an amount of current being output by the first electrochemical pumping cell. The first signal is indicative of an oxygen concentration in the first chamber. The NOx sensing system further includes a second voltage source configured to supply a voltage to the third electrochemical pumping cell. The NOx sensing system further includes a second current sensor configured to output a second signal indicative of an amount of current being output by the third electrochemical pumping cell. The second signal is indicative of a NOx concentration in the fourth chamber. The NOx sensing system further includes a controller operably coupled to the first voltage source, the first current sensor and the second current sensor. The controller is configured to generate the control signal received by the first voltage source based on the first signal from the first current sensor. The controller is further configured to receive the second signal and to determine a NOx concentration value indicative of the NOx concentration in the fourth chamber based on the second signal. The controller is further configured to store the NOx concentration value in a memory device.

### BRIEF DESCRIPTION OF THE DRAWINGS

FIG. 1 is a block diagram of a NOx sensing system having a NOx sensor in accordance with an exemplary embodiment;

FIG. 2 is a detailed cross-sectional schematic of the NOx sensor of FIG. 1;

FIGS. 3-5 are flowcharts of a method for determining a NOx concentration utilizing the NOx sensing system of FIG. 1 in accordance with another exemplary embodiment;

FIG. 6 is a signal schematic illustrating exemplary signals generated by the NOx sensor of FIG. 2; and

FIG. 7 is a signal schematic illustrating exemplary signals generated by the NOx sensor of FIG. 2.

### DETAILED DESCRIPTION OF EXEMPLARY EMBODIMENTS

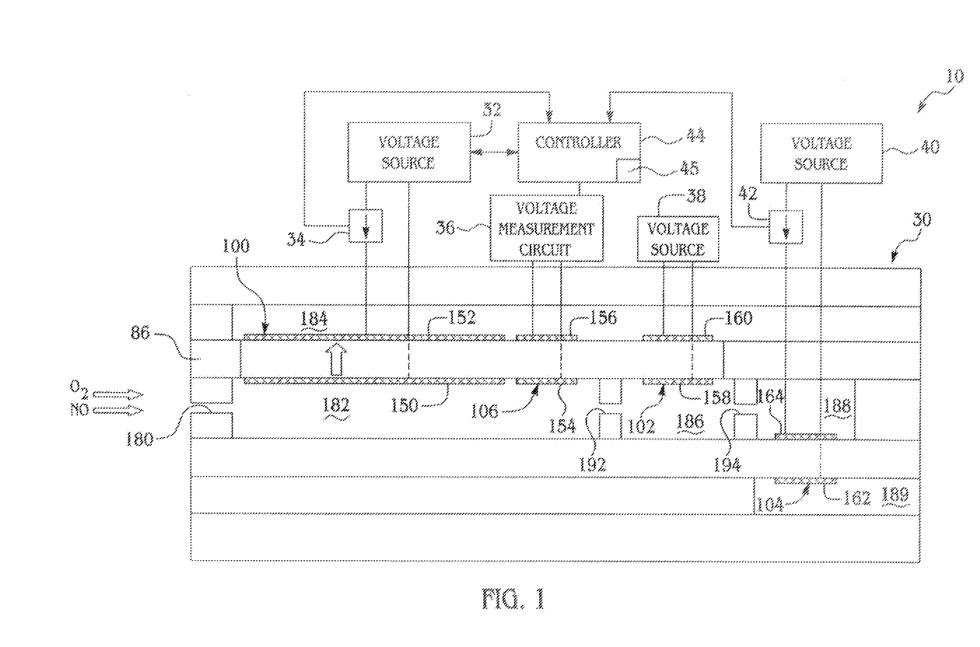

Referring to FIG. 1, a NOx sensing system 10 for determining a concentration of nitrogen oxides (NOx) in an exhaust stream is illustrated. The NOx sensing system 10 includes a NOx sensor 30, a voltage source 32, a current sensor 34, a voltage measurement circuit 36, a voltage source 38, a voltage source 40, a current sensor 42, and a controller 44.

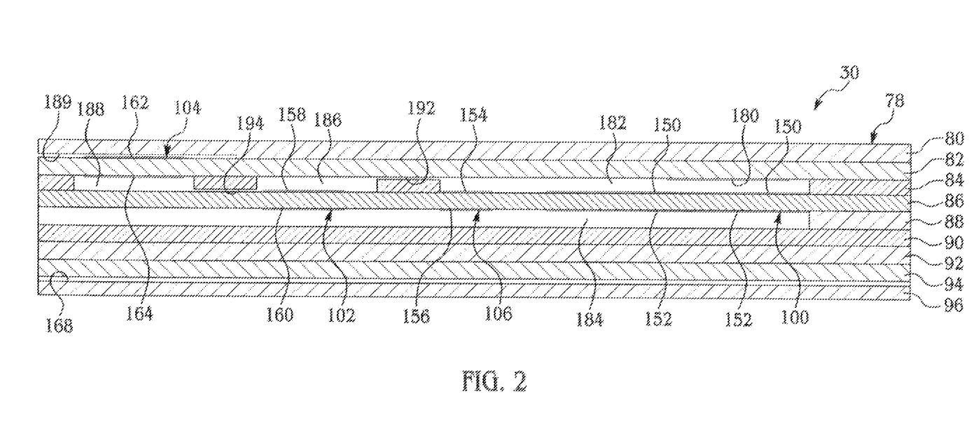

Referring to FIGS. 1 and 2, the NOx sensor 30 is provided to generate a signal indicative of a NOx concentration in an exhaust stream. The NOx sensor 30 includes a housing 78 comprising alumina layers 80, 84, 88, 90, 94, 96 and zirconia layers 82, 86, 92. The NOx sensor 30 further includes electrochemical pumping cells 100, 102, 104, a reference electrochemical cell 106, and a heater coil 108.

The zirconia layer 82 is disposed between alumina layers 80 and 84. The zirconia layer 86 is disposed between alumina layers 84 and 88. The alumina layer 90 is disposed between alumina layer 88 and zirconia layer 92. The alumina layer 94 is disposed between zirconia layer 92 and the alumina layer 96.

As illustrated, a chamber 182 is formed between a portion of the zirconia layer 82 and the zirconia layer 86. The chamber 182 fluidly communicates with a diffusion channel 180. The diffusion channel 180 routes gases from an exhaust stream containing at least oxygen and NOx exhaust gas constituents into the chamber 182.

Further, a chamber 184 is formed between a portion of the zirconia layer 86 and the alumina layer 90. The chamber 184 fluidly communicates with ambient atmosphere.

Further, a chamber 186 is formed between a portion of the zirconia layer 82 and the zirconia layer 86. A diffusion channel 192 is formed between a portion of the zirconia layer 82 and the alumina layer 84. The diffusion channel 192 routes exhaust gas constituents including NOx and low levels of oxygen from the chamber 182 into the chamber 186.

Further, a chamber 188 is formed between a portion of the zirconia layer 82 and a portion of the zirconia layer 86. A diffusion channel 194 is formed between a portion of the zirconia layer 82 and the alumina layer 84. The diffusion channel 194 routes exhaust gas constituents including NOx from the chamber 186 into the chamber 188.

Further, a chamber 189 is formed between a portion of the alumina layer 80 and the zirconia layer 82. The chamber 189 fluidly communicates with ambient atmosphere.

The electrochemical pumping cell 100 is provided to conduct oxygen ions from the chamber 182 to the chamber 184 to lower an oxygen concentration in the chamber 182. The electrochemical pumping dell 100 includes electrodes 150, 152 disposed on opposite sides of the zirconia layer 86 and a portion of the zirconia layer 86 disposed between electrodes 150, 152. In one exemplary embodiment, the electrode 150 is a pure-platinum electrode and the electrode 152 is a pure-platinum electrode. Of course, in alternative embodiment, other materials such as platinum alloys could be utilized to construct electrodes 150, 152. During operation, the voltage source 32 applies a voltage across the electrode 150, 152 which induces the cell 100 to pump oxygen ions from the chamber 182 to the chamber 184.

The reference electrochemical cell 106 is provided to generate a voltage indicative of an oxygen concentration in chamber 182 relative to the oxygen concentration of ambient atmosphere in chamber 184. The reference electrochemical cell 106 includes electrodes 154, 156 disposed on opposite sides of the zirconia layer 86 and a portion of the zirconia layer 86 disposed between electrodes 154, 156. In one exemplary embodiment, the electrode 154 is a platinum electrode and the electrode 156 is a platinum electrode. Of course in an alternative embodiment, one or more other precious metals known to those skilled in the art could be utilized to construct the electrodes 154, 156, such as a platinum alloy for example. When opposite surfaces of the electrochemical cell 106 are exposed to different oxygen partial pressures, an electromotive force, or voltage is induced between the electrodes 154, 156. The relationship between the oxygen partial pressures and the electromotive force is described by the Nernst equation:

$$EMF = ( \frac{- RT}{4 F} ) ln ( \frac{{P}_{{O}_{2}}^{ref}}{{P}_{{O}_{2}}} )$$

where: EMF=electromotive force
R=universal gas constant
F=Faraday constant
P_{O}_{₂}^{ref}=oxygen partial pressure of the reference gas in chamber 184
P_{O}_{₂}=oxygen partial pressure of the exhaust gas in chamber 182

The electrochemical pumping cell 102 is provided to conduct oxygen ions from the chamber 186 to the chamber 184 to lower an oxygen concentration in the chamber 186. The electrochemical pumping cell 102 includes electrodes 158, 160 disposed on opposite sides of the zirconia layer 86 and a portion of the zirconia layer 86 disposed between the electrodes 158,160. In one exemplary embodiment, the electrode 158 is a platinum-gold electrode and the electrode 160 is a platinum electrode. Of course, in an alternative embodiment, other materials known to those skilled in the art could be utilized to construct electrodes 158, 160. During operation, the voltage source 38 applies a voltage across the electrodes 158, 160 which induces the cell 112 to pump oxygen ions from the chamber 186 to the chamber 184, such that an oxygen concentration in the chamber 184 is reduced to an extremely low oxygen concentration level.

The electrochemical pumping cell 104 is provided to output a current indicative of a NOx concentration in the chamber 188 which is further indicative of the NOx concentration in the exhaust stream. The electrochemical pumping cell 104 includes electrodes 162, 164 disposed on opposite sides of the zirconia layer 82 and a portion of the zirconia layer 82 disposed between the electrodes 162, 164. In one exemplary embodiment, the electrode 164 is a rhodium electrode and the electrode 162 is a platinum electrode. Of course, in an alternative embodiment, other materials known to those skilled in the art could be utilized to construct the electrodes 162, 164. During operation, the voltage source 40 applies a voltage across the electrodes 162, 164 that induces the cell 104 to disassociate the NOx into nitrogen and oxygen and then pump oxygen ions from the chamber 188 to the chamber 189, wherein the current level flowing through the cell 104 is indicative of a NOx concentration in the chamber 188.

Referring to FIG. 1, the voltage source 32 is provided to apply a variable voltage level to the electrochemical pumping cell 100, based on a control signal from the controller 44. As illustrated, the voltage source 32 is electrically coupled to electrodes 150, 152 and to the controller 44.

The current sensor 34 is provided to generate a signal indicative of an amount of electrical current flowing through the electrochemical pumping cell 100, which is received by the controller 44. The current sensor 34 is electrically coupled to both the voltage source 32 and the electrode 152 of the cell 100.

The voltage measurement circuit 36 is provided to measure a voltage output by the reference electrochemical cell 106 which is indicative of an oxygen concentration in the chamber 182, and to generate a signal indicative of the oxygen concentration level that is received by the controller 44. The controller 44 induces the voltage source 32 to adjust an output voltage level supplied to the cell 100, based on the signal from the voltage measurement circuit 36. The voltage measurement circuit 36 is electrically coupled to the electrodes 154, 156, and to the controller 44.

The voltage source 38 is provided to apply a voltage to the electrochemical pumping cell 102. As illustrated, the voltage source 38 is electrically coupled to the electrodes 158, 160 of the electrochemical pumping cell 102.

The voltage source 40 is provided to apply a voltage level to the electrochemical pumping cell 104. As illustrated, the voltage source 40 is electrically coupled to the electrodes 162, 164 of the cell 104.

The current sensor 42 is provided to generate a signal indicative of an amount of electrical current flowing through the electrochemical pumping cell 104, which is received by the controller 44. The current sensor 42 is electrically coupled to the voltage source 40 and the electrode 164 of the cell 104, and to the controller 44.

Referring to FIG. 2, the heater coil 108 is provided to generate heat for maintaining a temperature of the NOx sensor 30 within a desired temperature range. The heater coil 108 is disposed between a portion of the alumina layer 94 and the alumina layer 96. The heater coil 108 generates heat based on a control signal from the controller 44.

Referring to FIG. 1, the controller 44 is provided to calculate a NOx concentration value based on a signal from the current sensor 42 indicative of the NOx concentration detected by the electrochemical pumping cell 104. The controller 44 is further provided to generate control signals for the voltage source 32 to adjust a voltage applied to the electrochemical pumping cell 100, based on a signal received from the voltage measurement circuit 36. By adjusting a voltage applied to the electrochemical pumping cell 100, an oxygen concentration in the chamber 182 can be adjusted toward a desired oxygen concentration level. In one exemplary embodiment, the desired oxygen concentration level in the chamber 182 is within a range of 100-150 parts-per-million of oxygen. Of course, in an alternative embodiment, the desired oxygen concentration level in the chamber 182 could be outside the range of 100-150 parts-per-million of oxygen. The controller 44 is further provided to receive signals from the current sensor 34.

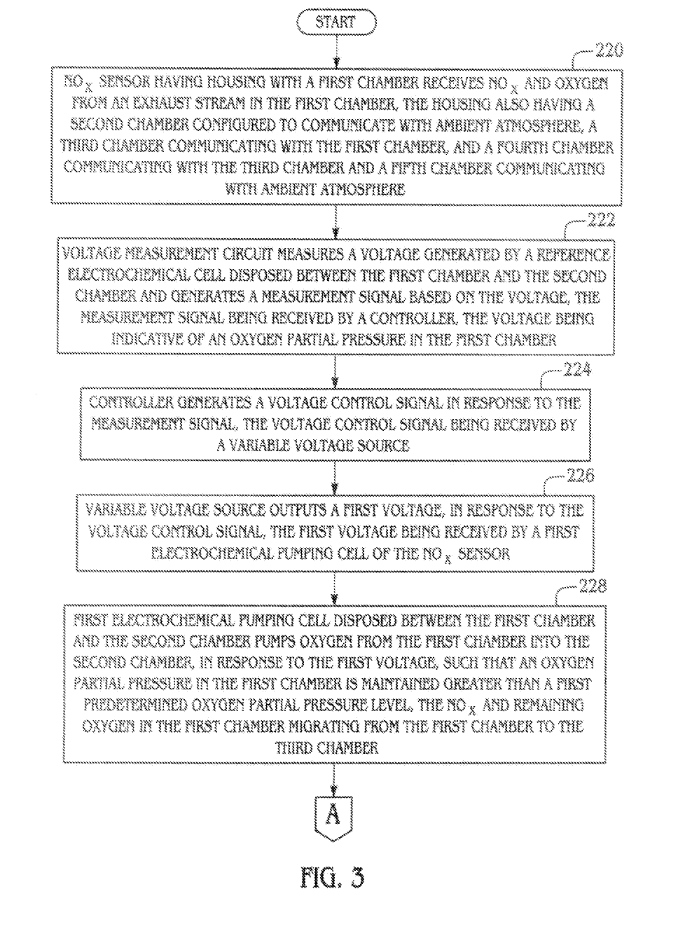

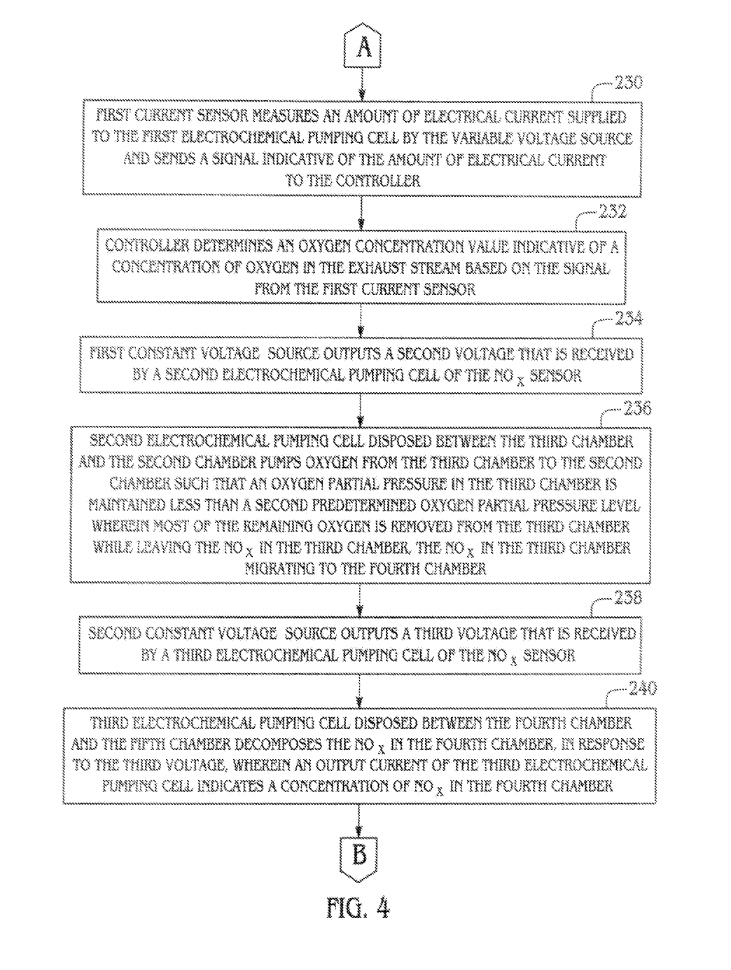

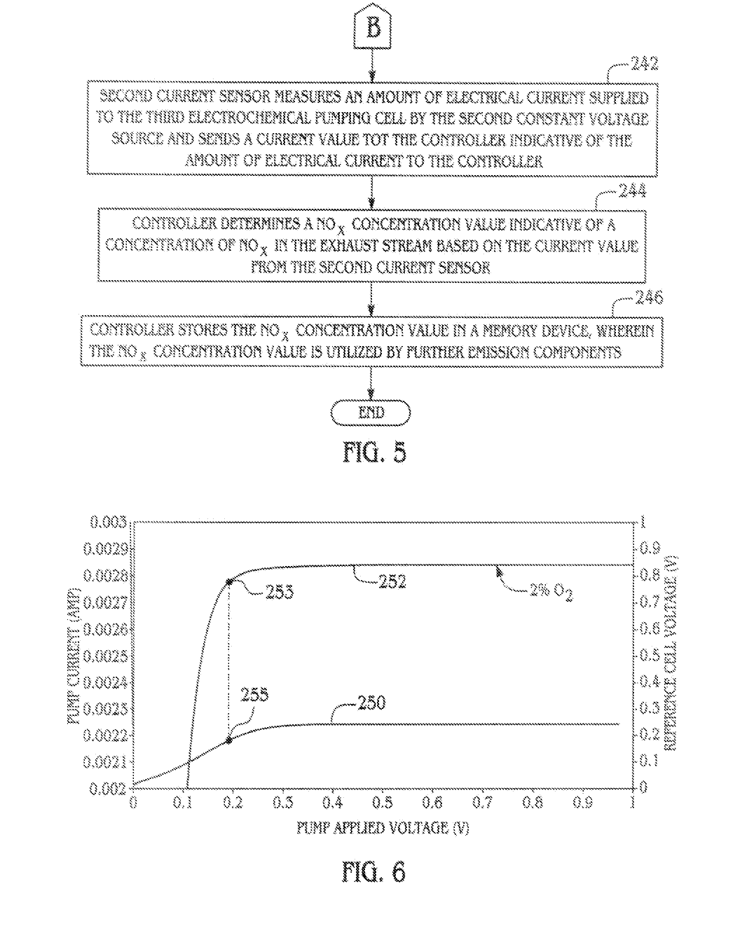

Referring to FIGS. 3-5, a method for determining a NOx concentration in an exhaust stream utilizing the NOx sensing system 10 will now be explained.

At step 220, the NOx sensor 30 having the housing 78 with the chamber 182 receives NOx and oxygen from an exhaust stream in the chamber 182 via the diffusion channel 180. The housing 78 also has chambers 184, 186, 188 and 189. The chamber 184 is configured to communicate with ambient atmosphere. The chamber 186 communicates with the chamber 182, and the chamber 188 communicates with the chamber 186. Further, the chamber 189 communicates with ambient atmosphere.

At step 222, the voltage measurement circuit 36 measures a voltage generated by a reference electrochemical cell 102 disposed between the chamber 184 and the chamber 186 and generates a measurement signal based on the received voltage. The measurement signal is received by the controller 44. The voltage is indicative of an oxygen partial pressure in the chamber 182.

At step 224, the controller 44 generates a voltage control signal in response to the measurement signal. The voltage control signal is received by the variable voltage source 32.

At step 226, the variable voltage source 32 outputs a first voltage, in response to the voltage control signal. The first voltage is received by the electrochemical pumping cell 100 of the NOx sensor 30.

At step 228, the electrochemical pumping cell 100 disposed between the chamber 182 and the chamber 184 pumps oxygen from the chamber 182 into the 184, in response to the first voltage, such that an oxygen partial pressure in the chamber 182 is maintained greater than a first predetermined oxygen partial pressure level. The NOx and remaining oxygen in the chamber 182 migrates from the chamber 182 to the chamber 186.

At step 230, the current sensor 34 measures an amount electrical current supplied to the electrochemical pumping cell 100 by the variable voltage source 32 and sends a signal indicative of the amount of electrical current to the controller 44.

At step 232, the controller 44 determines an oxygen concentration value indicative of a concentration of oxygen in the exhaust stream based on the signal from the current sensor 34.

At step 234, the constant voltage source 38 outputs a second voltage that is received by the electrochemical pumping cell 102 of the NOx sensor 30.

At step 236, the electrochemical pumping cell 102 disposed between the chamber 186 and the chamber 184 pumps oxygen from the chamber 186 to the chamber 184 such that an oxygen partial pressure in the chamber 186 is maintained less than a second predetermined oxygen partial pressure level wherein most of the remaining oxygen is removed from the chamber 186 while leaving the NOx in the chamber 186. The NOx in the chamber 186 migrates to the chamber 188.

At step 238, the constant voltage source 40 outputs a third voltage that is received by the electrochemical pumping cell 104 of the NOx sensor 30.

At step 240, the electrochemical pumping cell 104 disposed between the chamber 188 and the chamber 189 decomposes the NOx in the chamber 188, in response to the third voltage, wherein an output current of the electrochemical pumping cell 104 indicates a concentration of NOx in the chamber 188.

At step 242, the current sensor 42 measures an amount of electrical current supplied to the electrochemical pumping cell 104 by the constant voltage source 40 and sends a current value to the controller 44 indicative of the amount of electrical current to the controller 44.

At step 244, the controller 44 determines a NOx concentration value indicative of a concentration of NOx in the exhaust stream based on the current value from the current sensor 42.

At step 246, the controller 44 stores the NOx concentration value in a memory device 45, wherein the NOx concentration value can be used by other emission control components. After step 246, the method is exited.

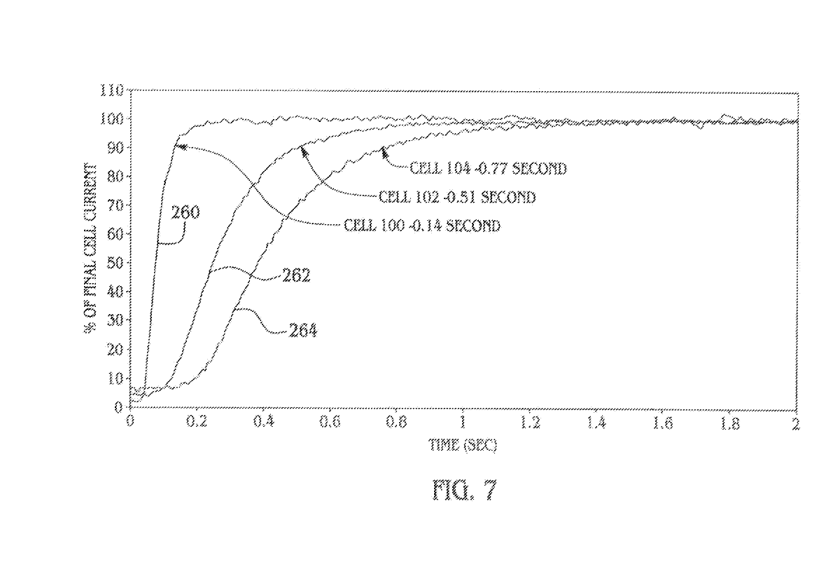

Referring to FIG. 6, signal curves describing operation of the electrochemical pumping cell 100 and the reference electrochemical cell 102 will now be explained. In particular, the signal curve 250 illustrates exemplary voltages generated by the reference electrochemical cell 102 indicating an oxygen concentration in the chamber 182. The signal curve 252 illustrates exemplary electrical current levels that can flow through the electrochemical pumping cell 100 while pumping oxygen ions from the chamber 182. As shown, a desired operational point 253 on the signal curve 252 indicates a desired electrical pumping current level that the controller 44 attempts to maintain for the electrochemical pumping cell when pumping oxygen ions from the chamber 182, without disassociating the NOx in the chamber 182. Further, the operational point 255 on signal curve 250 indicates a desired output voltage of the voltage measurement circuit 36 indicating a desired oxygen concentration in the chamber 182.

Referring to FIG. 7, signal schematics indicating a response time of the NOx sensor 30 will now be explained. In particular, the signal curve 260 indicates that the electrochemical pumping cell 100 has a response time of approximately 0.14 seconds. Further, the signal curve 262 indicates that the electrochemical pumping cell 102 has a response time of approximately 0.51 seconds. Further, the signal curve 264 indicates that the electrochemical pumping cell 104 has a response time of approximately 0.77 seconds.

The NOx sensor and the method for determining a NOx concentration in an exhaust stream provide a substantial advantage over other NOx sensors and methods. In particular, the NOx sensor and the method provide a technical effect of utilizing a first chamber communicating with ambient atmosphere with ambient oxygen for allowing an electrochemical cell to accurately measure an oxygen concentration in a second chamber communicating with an exhaust stream to more accurately control the oxygen concentration in the second chamber, without disassociating NOx therein. The more accurate control of the oxygen concentration in the second chamber, subsequently allows for a more accurate measurement of the NOx in the exhaust stream.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the sue of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A NOx sensor, comprising:
a housing having a first chamber configured to receive NOx and oxygen from an exhaust stream, a second chamber configured to communicate with ambient atmosphere, a third chamber communicating with the first chamber, and a fourth chamber communicating with the third chamber;
a first electrochemical pumping cell disposed between the first chamber and the second chamber, the first electrochemical pumping cell configured to pump oxygen from the first chamber into the second chamber such that an oxygen partial pressure in the first chamber is maintained greater than a first predetermined oxygen partial pressure level, the NOx and remaining oxygen in the first chamber migrating from the first chamber to the third chamber;
a second electrochemical pumping cell disposed between the third chamber and the second chamber, the second electrochemical pumping cell configured to pump oxygen from the third chamber to the second chamber such that an oxygen partial pressure in the third chamber is maintained less than a second predetermined oxygen partial pressure level, the NOx in the third chamber migrating to the fourth chamber; and
a third electrochemical pumping cell communicating with the fourth chamber, the third electrochemical pumping cell configured to decompose the NOx in the fourth chamber, wherein an output current of the third electrochemical pumping cell indicates a concentration of NOx in the fourth chamber.

2. The NOx sensor of claim 1, wherein the first electrochemical pumping cell has a first platinum electrode communicating with the first chamber and a second platinum electrode communicating with the second chamber.

3. The NOx sensor of claim 1, wherein the second electrochemical pumping cell has a platinum and gold electrode communicating with the third chamber and a platinum electrode communicating with the second chamber.

4. The NOx sensor of claim 1, wherein the third electrochemical pumping cell has a rhodium electrode communicating with the fourth chamber and a platinum electrode communicating with the second chamber.

5. The NOx sensor of claim 1, further comprising a reference electrochemical cell disposed between the first chamber and the second chamber, the reference electrochemical cell outputting a voltage indicative of the oxygen partial pressure in the first chamber.

6. A method for determining a concentration of NOx utilizing a NOx sensor, the NOx sensor having a housing with a first chamber configured to receive NOx and oxygen from an exhaust stream, a second chamber configured to communicate with ambient atmosphere, a third chamber communicating with the first chamber, and a fourth chamber communicating with the third chamber, the NOx sensor further having a first electrochemical pumping cell disposed between the first chamber and the second chamber, the NOx sensor further having a second electrochemical pumping cell disposed between the third chamber and the second chamber, the NOx sensor further having a third electrochemical pumping cell communicating with the fourth chamber, the method comprising:
pumping oxygen from the first chamber into the second chamber utilizing the first electrochemical pumping cell such that an oxygen partial pressure in the first chamber is maintained greater than a first predetermined oxygen partial pressure level, the NOx and remaining oxygen in the first chamber migrating from the first chamber to the third chamber;
pumping oxygen from the third chamber to the second chamber utilizing the second electrochemical pumping cell such that an oxygen partial pressure in the third chamber is maintained less than a second predetermined oxygen partial pressure level, the NOx in the third chamber migrating to the fourth chamber; and
decomposing the NOx in the fourth chamber utilizing the third electrochemical pumping cell, wherein an output current of the third electrochemical pumping cell indicates the concentration of NOx in the fourth chamber.

7. The method of claim 6, wherein the NOx sensor further comprises a reference electrochemical cell disposed between the first chamber and the second chamber, the method further comprising outputting a voltage indicative of the oxygen partial pressure in the first chamber utilizing the reference electrochemical cell.

8. A NOx sensing system, comprising:
a NOx sensor having a housing having a first chamber configured to receive NOx and oxygen from an exhaust stream, a second chamber configured to communicate with ambient atmosphere, a third chamber communicating with the first chamber, and a fourth chamber communicating with the third chamber, the NOx sensor further having a first electrochemical pumping cell disposed between the first chamber and the second chamber, the first electrochemical pumping cell configured to pump oxygen from the first chamber into the second chamber such that an oxygen partial pressure in the first chamber is maintained greater than a first predetermined oxygen partial pressure level, the NOx and remaining oxygen in the first chamber migrating from the first chamber to the third chamber, the NOx sensor further having a second electrochemical pumping cell disposed between the third chamber and the second chamber, the second electrochemical pumping cell configured to pump oxygen from the third chamber to the second chamber such that an oxygen partial pressure in the third chamber is maintained less than a second predetermined oxygen partial pressure level, the NOx in the third chamber migrating to the fourth chamber, the NOx sensor further having a third electrochemical pumping cell communicating with the fourth chamber, the third electrochemical pumping cell configured to decompose the NOx in the fourth chamber;
a first voltage source configured to supply a variable voltage to the first electrochemical pumping cell, in response to a control signal;
a first current sensor configured to output a first signal indicative of an amount of current being output by the first electrochemical pumping cell, the first signal being indicative of an oxygen concentration in the first chamber;
a second voltage source configured to supply a voltage to the third electrochemical pumping cell;
a second current sensor configured to output a second signal indicative of an amount of current being output by the third electrochemical pumping cell, the second signal being indicative of a NOx concentration in the fourth chamber; and
a controller operably coupled to the first voltage source, the first current sensor and the second current sensor, the controller configured to generate the control signal received by the first voltage source based on the first signal from the first current sensor, the controller further configured to receive the second signal and to determine a NOx concentration value indicative of the NOx concentration in the fourth chamber based on the second signal, the controller further configured to store the NOx concentration value in a memory device.

9. The NOx sensing system of claim 8, wherein the first electrochemical pumping cell of the NOx sensor has a first platinum electrode communicating with the first chamber and a second platinum electrode communicating with the second chamber.

10. The NOx sensing system of claim 8, wherein the second electrochemical pumping cell of the NOx sensor has a platinum and gold electrode communicating with the third chamber and a platinum electrode communicating with the second chamber.

11. The NOx sensing system of claim 8, wherein the third electrochemical pumping cell of thee NOx sensor has a rhodium electrode communicating with the fourth chamber and a platinum electrode communicating with the second chamber.

12. The NOx sensing system of claim 8, wherein the NOx sensor further comprises a reference electrochemical cell disposed between the first chamber and the second chamber, the reference electrochemical cell outputting a voltage indicative of the oxygen partial pressure in the first chamber.
